(19) United States
(12) Patent Application Publication
(10) Pub. No.: US 2012/0194482 A1
(43) Pub. Date: Aug. 2, 2012

(54) TOUCH PANEL

(75) Inventors: Jae Il KIM, Gyunggi-do (KR); Jong Young LEE, Gyunggi-do (KR); Yong Soo OH, Gyunggi-do (KR)

(73) Assignee: SAMSUNG ELECTRO-MECHANICS CO., LTD., Gyunggi-do (KR)

(21) Appl. No.: 13/083,418

(22) Filed: Apr. 8, 2011

(30) Foreign Application Priority Data
Feb. 1, 2011 (KR) 10-2011-0009887

(51) Int. Cl. G06F 3/042

(52) U.S. Cl. 345/176

(57) ABSTRACT

Disclosed herein is a touch panel 100. The touch panel 100 according to the present invention includes: transparent electrode patterns 120 formed on a surface of a transparent substrate 110 and patterned to have opening portions 125; and a light guide 130 disposed on an outside of the transparent substrate 110, the light guide 130 passing only the lights within a predetermined angle from a vertical direction with respect to the surface of the transparent substrate 110, among the lights incident onto the transparent electrode patterns 120 and the opening portions 125 and the lights reflected from the transparent electrode patterns 120 and the opening portions 125. The present invention selectively passes the lights incident onto the transparent electrode patterns 120 and the opening portions 125 within specific angles by employing the light guide 130, thereby improving the visibility of the touch panel 100.

### CROSS REFERENCE TO RELATED APPLICATION

This application claims the benefit of Korean Patent Application No. 10-2011-0009887, filed on Feb. 1, 2011, entitled “Touch Panel” which is hereby incorporated by reference in its entirety into this application.

### BACKGROUND OF THE INVENTION

1. Technical Field

The present invention relates to a touch panel.

2. Description of the Related Art

Due to the advance of computers using digital technology, assistive devices of the computers have also been developed. In addition, personal computers, portable transmitting apparatuses, or other private information processing apparatuses process graphics and text by using various input devices such as keyboards and mice.

However, since the use of the computers have gradually expanded due to the rapid progress of an information society, it is difficult to drive electronic products effectively by using only current keyboards and mice serving as input devices. Accordingly, there is a growing need to introduce the devices that are simple and less malfunctioning as well as that allows anyone to easily input information.

Beyond general functions of the input devices, techniques in connection with reliability, durability, innovation, design, and process become the new subject of interest thereof. In order to achieve this, a touch panel has been developed as an input device allowing the input of information such as text or graphics.

This touch panel is installed on a display surface of an image display device, such as, a flat panel display device, for example, an electronic notebook, an LCD (Liquid Crystal Display), a PDP (Plasma Display Panel), an El (Electroluminescence), and or the like, or a CRT (Cathode Ray Tube), and thus, allows a user to select desired information while watching the image display devices.

Meanwhile, the types of touch panels are a resistive type, a capacitive type, an electro-magnetic type, a surface acoustic wave (SAW) type, and an infrared type. These various types of touch panels are employed in electronic products, considering signal amplification, resolution difference, level of difficulty in design and process techniques, optical characteristics, electrical characteristics, mechanical characteristics, environmental stress resistance characteristics, input characteristics, durability, and economical efficiency. In the present, the most attractive types of touch panels are a capacitive type touch panel and a digital resistive type touch panel allowing multi-touch.

However, in the capacitive type touch panel and the digital resistive type touch panel according to the related art, the shape of a transparent electrode pattern may be recognized to a user due to intrinsic reflectance and color of the transparent electrode pattern. For example, the user would recognize a bar figure on an image when the transparent electrode pattern is patterned in a bar shape, and recognize a diamond figure on an image when the transparent electrode pattern is patterned in a diamond shape. As such, the touch panel according to the related art has problems in that the image outputted from the image display device is distorted and the visibility is entirely deteriorated due to the existence of the transparent electrode pattern.

### SUMMARY OF THE INVENTION

The present invention has been made in an effort to provide a touch panel for preventing a user from recognizing transparent electrode patterns by employing a light guide of selectively passing the lights within a predetermined angle.

According to a preferred embodiment of the present invention, there is provided a touch panel, including: transparent electrode patterns formed on a surface of a transparent substrate and patterned to have opening portions; and a light guide disposed on an outside of the transparent substrate, the light guide passing only the lights within a predetermined angle from a vertical direction with respect to the surface of the transparent substrate, among the lights incident onto the transparent electrode patterns and the opening portions and the lights reflected from the transparent electrode patterns and the opening portions.

The light guide may include a honeycomb structure formed in a vertical direction with respect to the surface of the transparent substrate, the light guide passing only the lights within a predetermined angle from the vertical direction with respect to the surface of the transparent substrate, among the lights incident onto the transparent electrode patterns and the opening portions and the lights reflected from the transparent electrode patterns and the opening portions through the honeycomb structure.

The honeycomb structure may be formed by removing alumina from aluminum, the alumina being formed through anodizing of the aluminum.

The transparent electrode patterns may be formed of a conductive polymer. The conductive polymer may include poly-3,4-ethylenedioxythiophene/polystyrenesulfonate (PEDOT/PSS), polyaniline, polyacetylene, or polyphenylenevinylene.

The opening portion has a correction pattern formed therein, the correction pattern having a color corresponding to a color of the transparent electrode pattern.

The opening portion has a correction pattern formed therein, the correction pattern having the same reflectance as the transparent electrode pattern.

### BRIEF DESCRIPTION OF THE DRAWINGS

FIGS. 1A and 1B are cross-sectional views of a touch panel according to a preferred embodiment of the present invention;

FIGS. 2A to 2C are enlarged views of parts A, B, and C shown in FIG. 1A, respectively;

FIG. 3 is an enlarged perspective view of a honeycomb structure; and

FIGS. 4 to 6 are cross-sectional views of touch panel manufactured according to preferred embodiments of the present invention, respectively.

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. It will be understood that, although the terms first, second, etc. may be used herein to describe various elements, these elements should not be limited by these terms. These terms are only used to distinguish one element from another. Further, when it is determined that the detailed description of the known art related to the present invention may obscure the gist of the present invention, the detailed description thereof will be omitted.

Hereinafter, preferred embodiments according to the present invention will be described in detail with reference to the accompanying drawings.

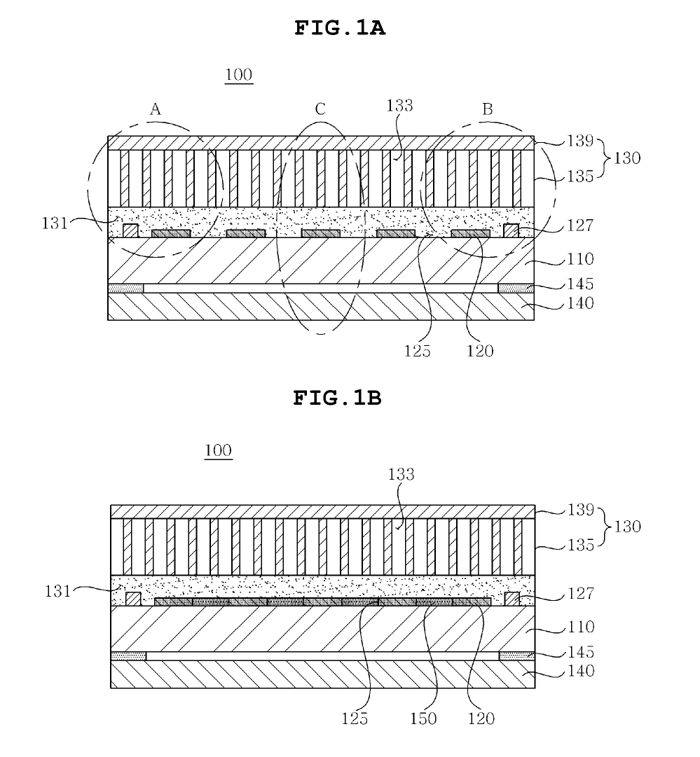

FIGS. 1A and 1B are cross-sectional views of a touch panel according to a preferred embodiment of the present invention. As shown in FIG. 1A, a touch panel 100 according to the present embodiment may include transparent electrode patterns 120 and a light guide 130. The transparent electrode patterns 120 are formed on a surface of a transparent substrate 110. The transparent electrode patterns are patterned to have opening portions 125. The light guide 130 is disposed on an outside of the transparent substrate 110 to pass only the lights within a predetermined angle from a vertical direction with respect to the surface of the transparent substrate 110 among the lights incident onto the transparent electrode patterns 120 and the opening portions 125 and the lights reflected from the transparent electrode patterns 120 and the opening portions 125.

The transparent substrate 110 performs a role of providing regions for the transparent electrode patterns 120, electrode wires 127, or the like. Herein, the transparent substrate 110 needs to have a support force for supporting the transparent electrode patterns 120 and the electrode wires 127, and a transparent property for enabling a user to recognize an image supplied by an image display device 140. Considering the above-described support force and transparent property, the transparent substrate 110 is preferably formed of polyethyleneterephthalate (PET), polycarbonate (PC), polymethylmetharcylate (PMMA), polyethylenenaphtalate (PEN), polyethersulfone (PES), cycloolefin copolymer (COC), triacetylcellulose (TAC) films, polyvinyl alcohol (PVA) films, polyimide (PI) films, polystyrene (PS), biaxially oriented polystyrene (BOPS, containing K resin), glass, tempered glass, or the like, but not necessarily limited thereto. Meanwhile, it is preferable to perform high frequency treatment or primer treatment on the surface of the transparent substrate 110 in order to increase an adhesive force between the transparent substrate 110 and the transparent electrode patterns 120.

The transparent electrode patterns 120 are formed on the surface of the transparent substrate 110 to perform a role of generating signals when an input unit is touched, so that a controller is capable of recognizing touch coordinates. Herein, the transparent electrode patterns 120 may be formed of indium thin oxide (ITO) commonly used, as well as a conductive polymer having excellent flexibility and allowing a simple coating process. The conductive polymer includes poly-3,4-ethylenedioxythiophene/poly(styrenesulfonate) (hereafter, PEDOT/PSS), polyaniline, polyacetylene, polyphenylenevinylene, or the like. Herein, the transparent electrode patterns 120 may be formed on the entire surface of the transparent substrate 110 by using a dry process such as sputtering, evaporation, or the like, or a wet process such as dip coating, spin coating, roll coating, spray coating, or the like, followed by laser processing or wet etching. Besides, the transparent electrode patterns 120 may be formed directly on the transparent substrate 110 by using a direct patterning process such as screen printing, gravure printing, inkjet printing, or the like. Herein, each of the transparent electrode patterns 120 may be patterned in at least one selected from all patterns known to the art, such as a bar shape, a diamond shape, a circle shape, a square shape, and the like.

Meanwhile, when the transparent electrode patterns 120 are patterned to have the opening portions 125, a difference in reflectance or color between the transparent electrode pattern 120 and the opening portion 125 is generated due to intrinsic reflectance or color of the transparent electrode pattern 120. In particular, the transparent electrode pattern 120 formed of PEDOT/PSS is difficult to put to practical use because of a large significant difference in reflectance between the transparent electrode pattern 120 and the opening portion 125, as well as a difference in color between the transparent electrode pattern 120 and the opening portion 125 caused by blue color expressed by the transparent electrode pattern 120. However, since the touch panel 100 according to the present invention is capable of preventing a user from visually recognizing the difference in reflectance or color between the transparent electrode pattern 120 and the opening portion 125 by employing the light guide 130, it is possible to form the transparent electrode pattern 120 made of PEDOT/PSS. The explanation of how the light guide 130 can prevent the user from recognizing the difference in reflectance or color between the transparent electrode pattern 120 and the opening portion 125 will be described below.

On the other hand, the electrode wires 127 for receiving electric signals from the transparent electrode patterns 120 are printed outside the transparent electrode patterns 120. Herein, an Ag paste having excellent electrical conductivity or a material composed of organic silver is preferably used as materials for the electrode wires 127, but not necessarily limited thereto. A conductive polymer, carbon black (containing CNT), or a low resistive to metal material, for example, metal oxides such as ITO, and metals may be used as the materials for the electrode wires 127.

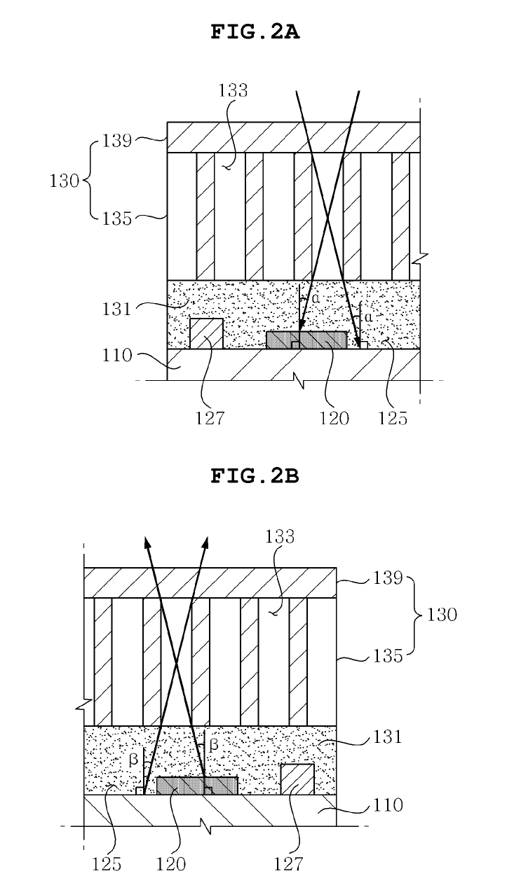

The light guide 130 performs a role of preventing a user from recognizing the shape of the transparent electrode pattern 120 by selectively passing the lights incident onto the transparent electrode patterns 120 and the opening portions 125 and the lights reflected from the transparent electrode patterns 120 and the opening portions 125. Herein, the light guide 130 is attached on an upper surface of the transparent substrate 110 by a first adhesive layer 131 such that the light guide 130 is disposed on the outside of the transparent substrate 110. FIGS. 2A to 2C are enlarged views of parts A, B and C shown in FIG. 1A, respectively, and the light guide 130 will be described with reference to the drawings. As shown in FIGS. 2A to 2B, the light guide 130 includes a honeycomb structure 135 formed in a vertical direction with respect to the surface of the transparent substrate 110. Accordingly, the lights pass through only light paths 133 of the honeycomb structure 135 of the light guide 130. As a result, only the lights within a predetermined angle (hereafter, a specific angle) from the vertical direction with respect to the surface of the transparent substrate 110 are capable of passing through the light guide 130. That is, as shown in FIG. 2A, the lights incident onto the transparent electrode patterns 120 and the opening portions 125 are restricted within a specific angle α in the light guide 130, and pass through the light guide 130. As a result, the amount of lights incident onto the transparent electrode patterns 120 and the opening portions 125 is minimized, and thus, the amount of lights reflected from the transparent electrode patterns 120 and the opening portions 125 are reduced, thereby reducing the differences in reflectance or color between the transparent electrode pattern 120 and the opening portion 125 recognized by the user. In addition, as shown in FIG. 2B, the lights reflected from the transparent electrode patterns 120 and the opening portions 125 are also restricted within a specific angle β in the light guide 130, and pass through the light guide 130. Eventually, the lights reflected from the transparent electrode patterns 120 and the opening portions 125 are again restricted within the specific angle β in the light guide 130, to and pass through the light guide 130, thereby further reducing the difference in reflectance or color between the transparent electrode pattern 120 and the opening portion 125 recognized by the user. The specific angles α and β are determined according to a diameter or a height of the light path 133. That is, the specific angles widen if the diameter of the light path 133 is increased, and the specific angles narrow if the diameter of the light path 133 is decreased. The specific angles narrow if the height of the light path 133 is increased, and the specific angles widen if the height of the light path 133 is decreased. In addition, the amount of lights passing through the light guide 130 is determined by the number of light paths 133 per unit area. That is, the amount of lights passing through the light guide 130 can be increased if the number of light paths 133 per unit area is increased, and the amount of lights passing through the light guide 130 can be reduced if the number of light paths 133 per unit area is decreased. Accordingly, the difference in reflectance or color between the transparent electrode pattern 120 and the opening portion 125 can be effectively reduced by adjusting the diameter or the height of the light paths 133, or the number of the light paths 133 per unit area, considering the shape of the transparent electrode pattern 120 or an area ratio between the transparent electrode pattern 120 and the opening portion 125.

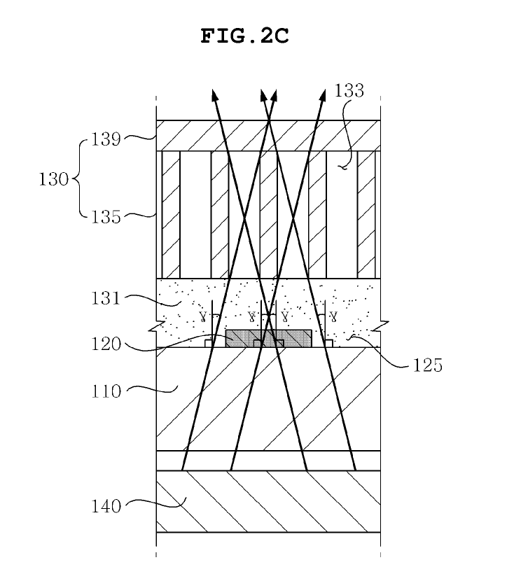

Meanwhile, the honeycomb structure 135 including the light paths 133 may be formed by anodizing of aluminum. In order to form the honeycomb structure 135, first, aluminum is submerged in an electrolyte made of sulfuric acid, oxalic acid, or phosphoric acid. Then, a voltage is applied between an anode and a cathode while the aluminum is put as the anode in the electrolyte. As a result, the aluminum is partially oxidized to form alumina Al₂O₃. Then, the alumina is removed by a cleaning process, thereby forming the honeycomb structure 135 in which cylindrical or hexagonal cylindrical light paths 133 are regularly arranged, as shown in FIG. 3. Meanwhile, the diameter and the height of the light path 133, and the number of light paths 133 per unit area, in the honeycomb structure 135, can be adjusted according to the kind and the concentration of the electrolyte and the level of an applied voltage. Therefore, the difference in reflectance or color between the transparent electrode pattern 120 and the opening portion 125 can be effectively reduced by adjusting the diameter and the height of the light path 133, and the number of light paths 133 per unit area, in the honeycomb structure 135, considering the shape of the transparent electrode pattern 120 and the area ratio between the transparent electrode pattern 120 and the opening portion 125. In addition, since the light paths 133 of the honeycomb structure 135 completed according to the above-described process have a uniform size and very regular arrangement over a large area, the honeycomb structure 135 is suitable to use in the light guide 130. The forming the light guide 130 by anodizing of aluminum is just for illustration, and the present invention is not necessarily limited thereto. Obviously, all kinds of the light guides 130 known to the art may be used in the present invention.

Meanwhile, the honeycomb structure 135 is supported by a support substrate 139 (see FIG. 1A). That is, the light guide 130 may be composed of the honeycomb structure 135 and the support substrate 139. Herein, the support substrate 139 needs to have a support force for supporting the honeycomb structure 135 and a transparent property for allowing the passage of light. Therefore, the support substrate 139, similarly to the above-described transparent substrate 110, my be formed of polyethyleneterephthalate (PET), polycarbonate (PC), polymethylmetharcylate (PMMA), polyethylenenaphtalate (PEN), polyethersulfone (PES), cycloolefin copolymer (COC), triacetylcellulose (TAC) films, polyvinyl alcohol (PVA) films, polyimide (PI) films, polystyrene (PS), biaxially oriented polystyrene (BOPS, containing K resin), glass, tempered glass, or the like.

An image display device 140 is attached onto a lower surface of the transparent substrate 110 by a second adhesive layer 145. Herein, the image display device 140 performs a role of outputting an image, and includes a liquid crystal display (LCD), a plasma display panel (PDP), an electroluminescence (EL), a cathode ray tube (CRT), and the like. On the other hand, as shown in FIG. 2C, the image outputted from the image display device 140 passes only within a specific angle γ from a vertical direction with respect to one surface of the transparent substrate 110 due to the light guide 130. Accordingly, the image is not recognizable to third parties other than a user, thereby protecting the privacy of the user.

Meanwhile, as shown in FIG. 1B, it is preferable to form a correction pattern 150 in the opening portion 125 between the transparent electrode patterns 120. The correction pattern 150 has a color corresponding to the color of the transparent electrode pattern 120 and the same reflectance as the transparent electrode pattern 120. As such, the employment of the correction pattern 150 leads to complete removal of the color difference or the reflectance difference between the transparent electrode pattern 120 and the opening portion 125, thereby further improving the visibility of the touch panel 100. For example, when the transparent electrode pattern 120 is formed of PEDOT/PSS, the transparent electrode pattern 120 has an L* value of 90 to 96, an a* value of −2.0 to 2.0, and a b* value of −2.0 to 4.0, based on the L*a*b* color system. In the L*a*b* color system defined by Commission Internationale de I′Eclairage (CIE) in 1976, the L* value indicates lightness, and the a* value and the b* value indicate hue and chroma respectively. Preferably, the correction pattern 150 has an L* value of 90 to 96, an a* value of −2.0 to 2.0, and a b* value of −2.0 to 4.0, based on the L*a*b* color system. On the other hand, it is preferable to form the correction pattern 150 of a nonconductive material in order to prevent electrical short between the correction pattern 150 and the transparent electrode pattern 120. More specially, the correction pattern 150 may be formed by mixing a color ink containing pigments or dyes into polyethyleneterephthalate (PET) or polymethylmetharcylate (PMMA), but these are just for illustration. A nonconductive and colorable material may be used in the correction pattern 150 without limitation.

As shown in FIGS. 1A and 1B, as for the touch panel 100 according to the present embodiment, a self capacitive type touch panel or a mutual capacitive type touch panel can be manufactured by using the transparent electrode patterns 120 each having a single-layer structure. However, the touch panel 100 according to the present invention is limited thereto, and various types of touch panels including the above constitution can be manufactured as follows.

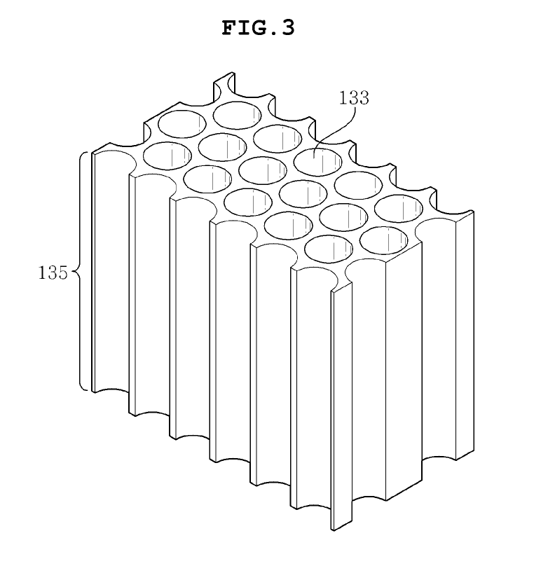

FIGS. 4 to 6 are cross-sectional views of touch panels manufactured according to preferred embodiments of the present invention, respectively.

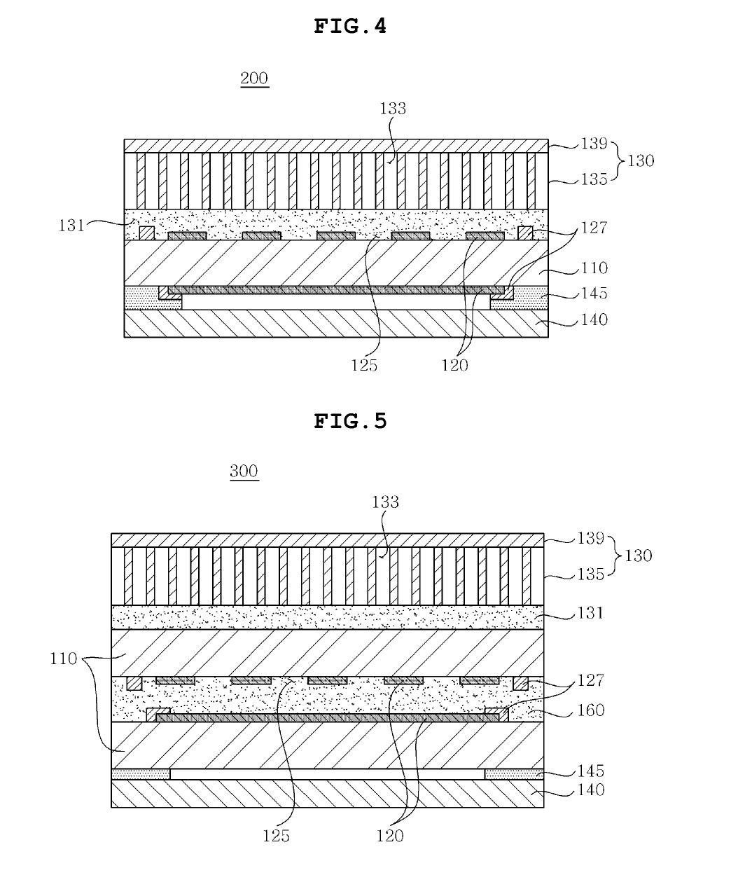

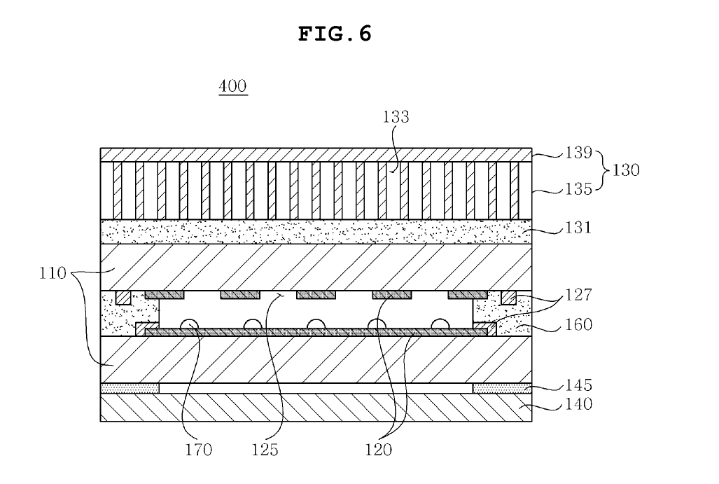

As shown in FIG. 4, a mutual capacitive type touch panel 200 (see, FIG. 4) can be manufactured by forming transparent electrode patterns 120 on both surfaces of a transparent substrate 110, respectively. In addition, as shown in FIGS. 5 and 6, a mutual capacitive type touch panel 300 (see FIG. 5) or a digital resistive type touch panel 400 (see FIG. 6) can be manufactured by preparing two transparent substrates 110 each having transparent electrode patterns 120 formed on one surface thereof and bonding the two transparent substrates 110 by a third adhesive layer 160 such that the transparent electrode patterns 120 face each other. Herein, in the mutual capacitive type touch panel 300 (see FIG. 5), the third adhesive layer 160 is attached on the entire surfaces of the transparent substrates 110 so that the two facing transparent electrode patterns 120 are insulated from each other. On the other hand, in the digital resistive type touch panel 400 (see FIG. 6), the third adhesive layer 160 is attached on only the edge portions of the transparent substrates 110 so that the two facing transparent electrode patterns 120 are contacted with each other when a pressure by an input unit is applied, and dot spacers 170 are provided on exposed surfaces of the transparent electrode patterns 120 so that the transparent electrode patterns 120 go back to original positions thereof due to repulsive forces of the dot spacers 170 when the pressure by the input unit is removed.

Each of the touch panels 200, 300 and 400 manufactured according to the preferred embodiments of the present invention, selectively, passes the lights incident onto the transparent electrode patterns 120 and the opening portions 125 and the lights reflected from the transparent electrode patterns 120 and the opening portions 125 only within the specific angles by employing the light guide 130, thereby improving the visibility of the touch panels 200, 300 and 400.

The present invention minimizes the amount of lights incident in a direction of the transparent electrode pattern and the opening portion (between the transparent electrode patterns) by employing the light guide for selectively passing only the lights within the specific angle, thereby improving the visibility of the touch panel.

In addition, the present invention selectively passes the lights reflected from the transparent electrode patterns and the opening portions within the specific angles by employing the light guide, thereby improving the visibility of the touch panel.

In addition, the present invention passes the image outputted from the image display device only within a specific angle by employing the light guide 130, and thus prevents third parties other than a user from recognizing the image, thereby protecting the privacy of the user.

Although the preferred embodiments of the present invention have been disclosed for illustrative purposes, they are for specifically explaining the present invention and thus a touch panel according to the present invention is not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch panel, comprising:
transparent electrode patterns formed on a surface of a transparent substrate and patterned to have opening portions; and
a light guide disposed on an outside of the transparent substrate, the light guide passing only the lights within a predetermined angle from a vertical direction with respect to the surface of the transparent substrate, among the lights incident onto the transparent electrode patterns and the opening portions and the lights reflected from the transparent electrode patterns and the opening portions.

2. The touch panel as set forth in claim 1, wherein the light guide includes a honeycomb structure formed in a vertical direction with respect to the surface of the transparent substrate, the light guide passing only the lights within a predetermined angle from the vertical direction with respect to the surface of the transparent substrate, among the lights incident onto the transparent electrode patterns and the opening portions and the lights reflected from the transparent electrode patterns and the opening portions through the honeycomb structure.

3. The touch panel as set forth in claim 2, wherein the honeycomb structure is formed by removing alumina from aluminum, the alumina being formed through anodizing of the aluminum.

4. The touch panel as set forth in claim 1, wherein the transparent electrode patterns are formed of a conductive polymer.

5. The touch panel as set forth in claim 4, wherein the conductive polymer includes poly-3,4-ethylenedioxythiophene/polystyrenesulfonate (PEDOT/PSS), polyaniline, polyacetylene, or polyphenylenevinylene.

6. The touch panel as set forth in claim 1, wherein the opening portion has a correction pattern formed therein, the correction pattern having a color corresponding to a color of the transparent electrode pattern.

7. The touch panel as set forth in claim 1, wherein the opening portion has a correction pattern formed therein, the correction pattern having the same reflectance as the transparent electrode pattern.
